(19) United States
(12) Patent Application Publication
(10) Pub. No.: US 2018/0095877 A1
(43) Pub. Date: Apr. 5, 2018

(54) PROCESSING SCATTERED DATA USING AN ADDRESS BUFFER

(71) Applicant: INTEL CORPORATION, Santa Clara, CA (US)

(72) Inventors: Aleksandar Beric, Eindhovenn (NL); Zoran Zivkovic, 's-Hertogenbosch (NL)

(73) Assignee: INTEL CORPORATION, Santa Clara, CA (US)

(21) Appl. No.: 15/281,288

(22) Filed: Sep. 30, 2016

(51) Int. Cl. G06F 12/0802; G06K 9/00

(52) U.S. Cl. CPC G06F 12/0802; G06F 2212/301; G06K 9/00986

(57) ABSTRACT

An example apparatus for processing scattered data includes an address buffer to receive a plurality of vector addresses corresponding to input vector data comprising scattered samples to be processed. The apparatus also includes a multi-bank memory to receive the input vector data and send output vector data. The apparatus further includes a memory controller comprising an address scheduler to assign an address to each bank of the multi-bank memory.

### BACKGROUND ART

Contemporary imaging and video applications, especially in the domain of automotive, surveillance, or computer vision may access scattered data in unpredictable and random manner. Such applications may include object detection algorithms, fine grained motion based temporal noise reduction or ultra-low light imaging, various fine grained image registration applications, example based super resolution techniques, various random sampling machine learning inference algorithms, etc. For example, object detection algorithms may include face detection and recognition.

### BRIEF DESCRIPTION OF THE DRAWINGS

FIG. 1 is a block diagram illustrating an example system for prefetching scattered data;

FIG. 2 is a detailed block diagram illustrating example system including a set of memory banks assigned to a subset of samples from an example region of interest;

FIG. 3 is a block diagram of an example two dimensional data split into three example types of memory banks;

FIG. 4 is a block diagram illustrating the operation of an example address scheduler that can schedule addresses based on a history of addresses;

FIG. 5 is a pair of block diagrams illustrating the reading efficiency of an example system without an address buffer versus an example system with an address buffer;

FIG. 6 is a graph illustrating average read performance as a function of number of memory banks;

FIG. 7 is a block diagram illustrating an example shuffling stage for writing data from memory banks to internal destination vector registers;

FIG. 8 is a block diagram of an example system for writing data to random memory locations;

FIG. 9 is a block diagram illustrating interfaces of an example memory subsystem with a fixed schedule;

FIG. 10 is detailed block diagram illustrating an example memory device for prefetching scattered data;

FIG. 11 is a block diagram illustrating an example multi-sample multi-bank memory;

FIG. 12 is a chart illustrating the performance of three example random data memory types in terms of an average samples per clock read from three example types of data access patterns;

FIG. 13 is a pair of line graphs illustrating silicon efficiency for two example multi-sample width configurations;

FIG. 14 is a flow chart illustrating a method for prefetching scattered data based on a fixed schedule;

FIG. 15 is a flow chart illustrating a method for prefetching scattered data based on a fixed performance;

FIG. 16 is block diagram illustrating an example computing device that can process images with prefetching of scattered data; and

FIG. 17 is a block diagram showing computer readable media that store code for enhanced prefetching of scattered data.

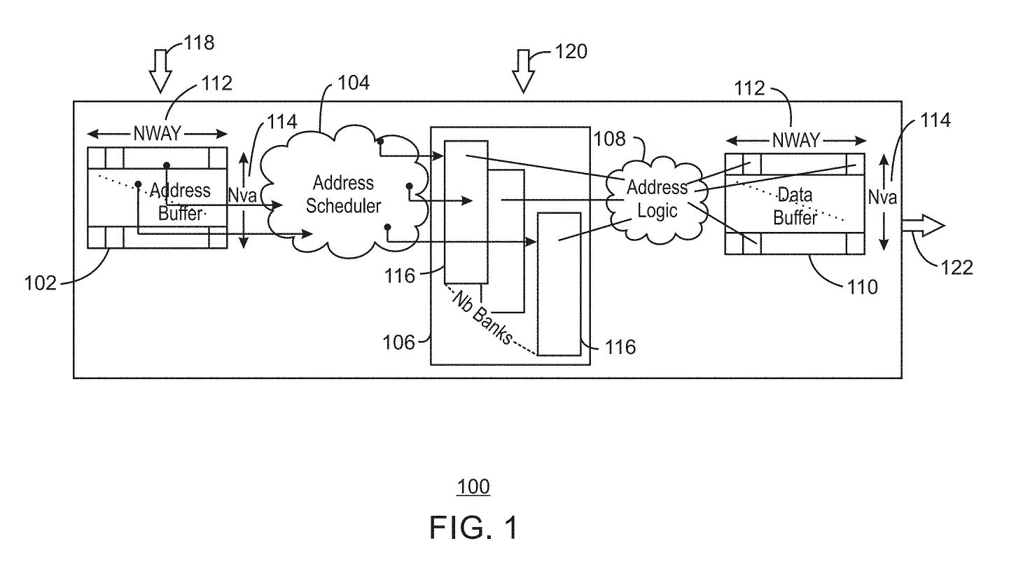

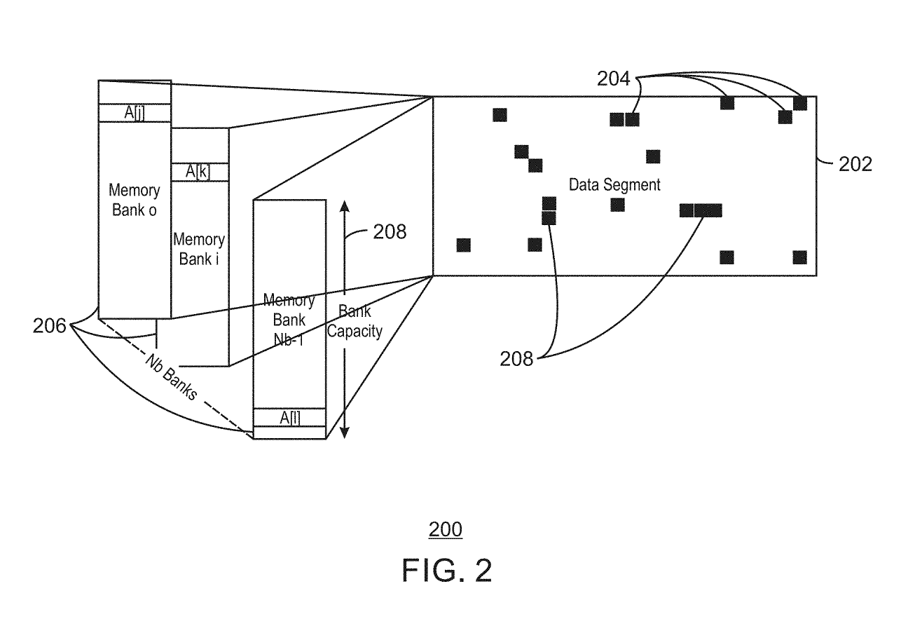

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE ASPECTS

As discussed above, current imaging and video applications may access scattered data in an unpredictable and random manner. In particular, a number of applications may use random sample access when processing image or video data. For example, in video-based or image-based object detection and recognition, an object may be detected in any part of an image. The position of the object in the video or image may be unknown before the image is processed. The detection algorithm typically access parts of image and individual feature samples. Since the objects are searched at different sizes, orientations, etc., the requirements for random sample access may be typically very high. Currently, many systems are therefore forced to work with frame rates and low resolutions.

In addition, motion compensation algorithms, such as temporal noise reduction algorithms, may use random sample access. For example, motion compensation algorithms may fetch data from previous images based on computed motion vectors. The motion vectors may be changing per frame and therefore require random access. For increasing image quality more fine grained access is required. Current systems however do not enable such fine grained random sample access.

Furthermore, machine learning and recognition applications may also use random sample access. For example, sparse matrix projections and sampling optimization methods, such as Markov chain Monte Carlo methods, are common elements of many machine learning and recognition algorithms. Some current face recognition algorithm may be based on a sparse matrix multiplication that requires 8 samples per clock from a 16 KB data space.

Currently, some memory architectures may provide efficient fetch of a group of samples, but not individual samples, and only under some strict conditions. For example, some current architectures may efficiently fetch of a group of mutually neighboring samples, shaped like a monolithic one dimensional or two dimensional blocks, but not individually scattered samples. In particular, high-performance processors, based on a vector or SIMD (Single Instruction Multiple Data stream) instruction sets, like an IPU (Imaging Processing Unit), may include such architectures. For example, an IPU's Vector Processor (VP) may be a programmable, SIMD core, built for the purpose to allow a flexible firmware and thus after-the-Silicon answer to application needs. However, current imaging or video use already exceeds 4k resolution at 60 frames per second (FPS) in real-time, and future processing may use even larger bandwidth such as 8k at 60 FPS.

A VP may thus include a high-performance architecture with a memory sub-system, vector data path, and vector instruction set designed to reach a peak at 32 or 64 samples per clock (SPCs). However, when the required input samples are scattered around the data space, the memory controller may not able to profit from any sample grouping, and the performance peak may drop to approximately one SPC, since the fetching may drop to just a single sample component per clock cycle. The slowdown in the fetching may also slow down data flow and thereby all subsequent processing stages. The sample fetching stage may also be quite early in the processing pipe, thus affecting the performance of an entire pipe by approximate factor of 32 or 64 depending on the parallelism available to the processor.

The present disclosure relates generally to techniques for processing scattered samples. Specifically, the techniques described herein include an apparatus, method and system for processing scattered data using a high-performance fetch for improved random sample access. An example apparatus includes an address buffer to receive a plurality of vector addresses corresponding to input vector data comprising scattered samples to be processed. The apparatus includes a multi-bank memory to receive the input vector data and send output vector data. The apparatus further includes a memory controller comprising an address scheduler to assign an address to each bank of the multi-bank memory. The techniques described herein thus enable fast access to random sample data scattered around a data space. For example, the data space may be an image, either as originally received or down-scaled by any factor. In particular, the use of a multiple memory banks may increase the silicon efficiency of memory, as well as the performance of memory during more complex modes of operation. In some examples, the techniques may include a high-performance fetch, achieved with significantly lower latency than 32 samples per clock (SPCs), with the possibility to pipeline the read requests, making this memory truly high-performance in a steady-state. For example, a typical operation may have a run-in period when the address buffer is filled, followed by the steady-state, and then followed by a run-out period in which the last vectors of data are retrieved. A new image processing may go through these three phases, and performance during the steady-state may be particularly improved with the present techniques. The techniques may thus also remove the bottleneck in the early fetching stage of an image processing pipelines, thus allowing the data path and instruction set to number-crunch full vectors of data. In some examples, the architecture of the system may be parametric. For example, the system may have two major parameters: the number of vector addresses NVa and the number of memory banks Nb at design time. The architecture may thus allow tradeoffs along two vectors: achieved peak performance against latency, and achieved peak performance against cost of implementation (power, and area). Faster random data access may enable many new applications. Alternatively, the techniques may enable finer grained random sample access.

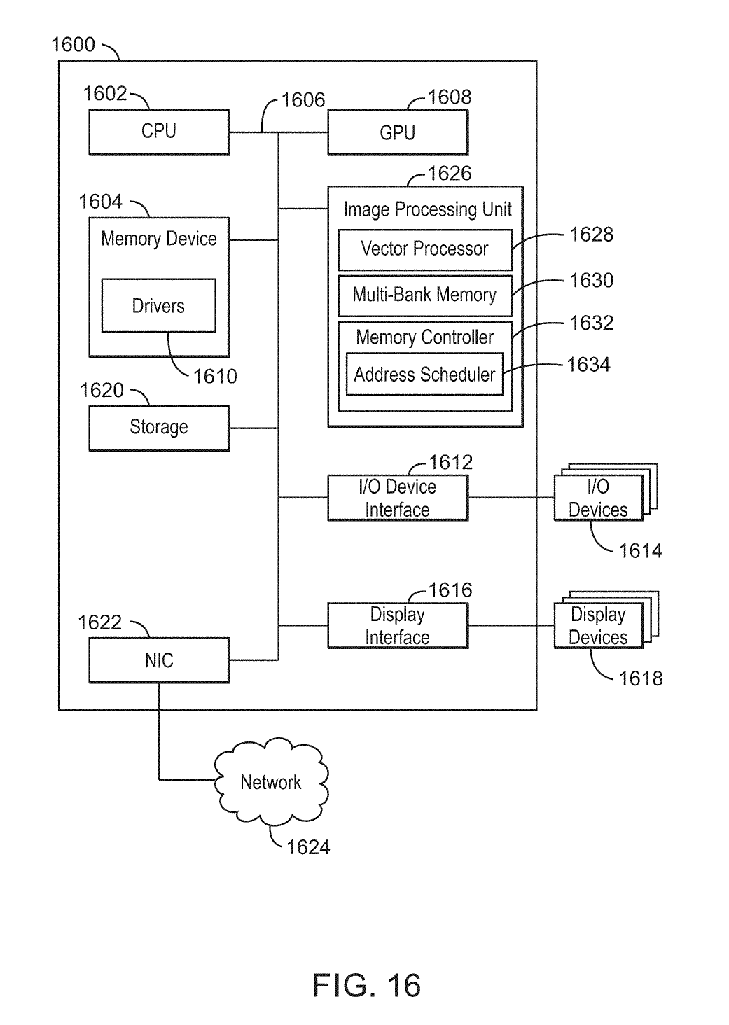

FIG. 1 is a block diagram illustrating an example system for prefetching scattered data. The example system is referred to generally by the reference number 100 and can be implemented in the image processing unit 1626 of the computing device 1602 below in FIG. 16. For example, the example system 100 can be implemented in the multi-bank memory 1630 and memory controller 1632 of the computing device 1602 below.

The example system 100 includes an address buffer 102, an address scheduler 104, a multi-bank memory subsystem 106, an address logic 108, and a data output buffer 110. For example, the address buffer 102 and data output buffer 110 may both be first-in, first-out (FIFO) buffers. The address buffer 102 and data output buffer 110 can both store a total of an NVa number of vector addresses 112 with an NWAY number of samples per vector word 114, referring to the parallelism available to the processor. A vector word, as used herein, thus refers to an NWAY number of samples, each sample having a predetermined number of bits. The multi-bank memory subsystem 106 includes a number Nb of memory banks 116. In some examples, the depth of the buffers NVa may be set to a value of 4, and the number of memory banks may be set to a value of 16.

As shown in FIG. 1, an address buffer 102 may receive a number of vector addresses 118. For example, the vector addresses may correspond to a number of samples from a region of interest (ROI) within an image being processed. The ROI including the samples may be input received as vector data 120. In some examples, the samples may be randomly scattered within the ROI. In some examples, the samples may be pseudo-randomly scattered in the region of interest. As used herein, pseudo-random or pseudo-randomly refers to the existence of some locality in the requested samples. For example, pseudo-randomly scattered samples may be grouped to a certain extent as shown in FIG. 2 below. In either case, the specific location or address of each sample in the region of interest may be unknown in advance. In some examples, the address buffer 102 may receive vector addresses in NWAY groups. NWAY may refer to the number of data that can be processed in parallel according to the single instruction, multiple data (SIMD) of a vector processor (VP) to process the ROI. For example, the value of NWAY may be 16, 32, 64, or 128, or any other suitable value depending on the vector processor being used.

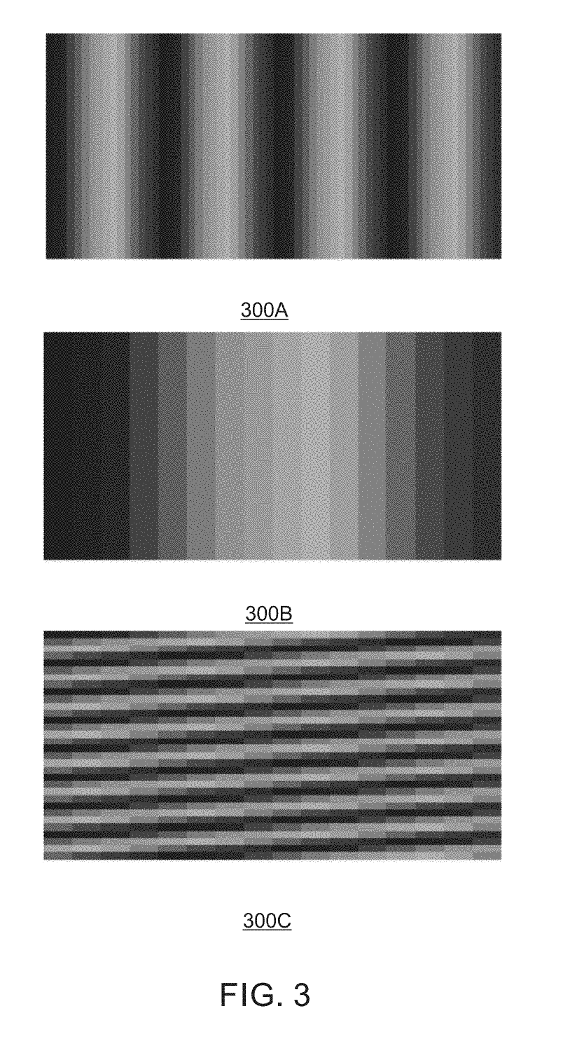

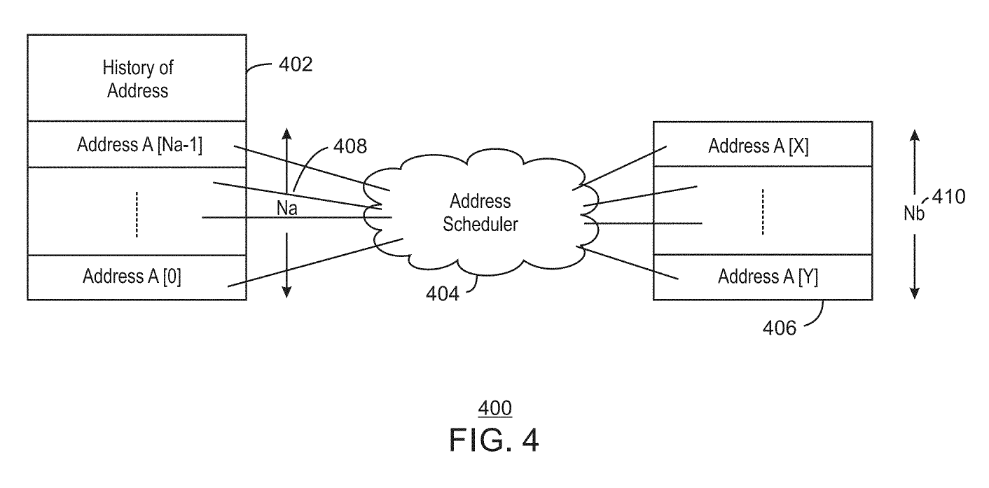

The vector data 120 may be stored within the multi-bank memory system 106. The vector data 120 may be stored and read from the multi-bank memory system 106 using a memory controller (not shown) including the address scheduler 104 and address logic 108. In some examples, the memory controller may be a hardware device that may feature a sophisticated reading and writing scheme with a built-in address history. The memory controller may thus store samples from the vector data 120 in the Nb number of memory banks 116 of the multi-bank memory subsystem 106. In some examples, the memory banks may be one sample wide. In some examples, the memory banks 116 may be multiple samples wide. In some examples, the address scheduler 104 may be a simple scheduler. For example, the address scheduler 104 may attempt to schedule each vector address to a corresponding memory bank and if the bank is already occupied, then the address vector may be scheduled for the next clock cycle. In some examples, the address scheduler 104 may use skewed addressing as described in greater detail below with respect to FIG. 3. In some examples, the address scheduler 104 may use an address history to provide address scheduling as discussed in greater detail with respect to FIG. 4 below.

The address logic 108 may then read vector data in the multi-bank memory system 106 and write the vector data to a data buffer 110. As mentioned above, the data buffer 110 may also have a capacity of NWAY×Nva samples. The data buffer 110 may then output vector data 122 for further processing.

The system 100 may thus deliver a vector of NWAY samples, within a minimal amount of clock cycles. In some examples, the memory subsystem 106 may be designed to accommodate an average amount of read cycles. For example, the number of clock cycles actually used to output a data vector may be within some distribution based on the randomness of the input vector data. Therefore, the performance and latency of the system 100 may be defined to accommodate average numbers. For example, the number of physically instantiated memory banks 116 may be fixed by design as well as the depth 114 of the address buffer 102 and the data buffer 110. However, in some examples, at compile-time, or run-time, the actual used depth 114 of the address buffer 102 can be made smaller to minimize latency. For example, the depth 114 size can be adjusted to be smaller according to any applied use case. In some examples, depth 114 adjustment may be implemented as part of the instruction set. For example, a flexible time-shape instruction may be used. In some examples, depth 114 adjustment may be implemented using several read instructions following different time shapes. For example, in some cases, using flexible time shape instructions may not be possible due to the very long instruction word (VLIW) tools limitations. In some examples, the VLIW limitations may be overcome as described below. In some examples, flexible time shapes can be used with CPUs, GPUs, and DSPs in general, where HW scheduling can be an out of order execution. Further, in cases where microthreading is available, out-of-order execution may also be possible. For example, a processor may switch to another thread, providing additional time to the memory to collect data.

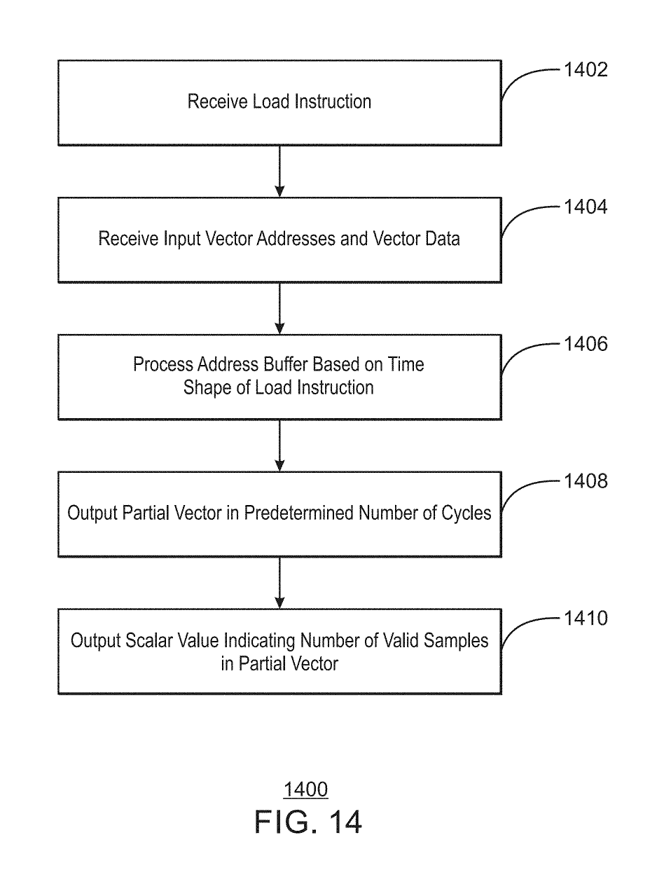

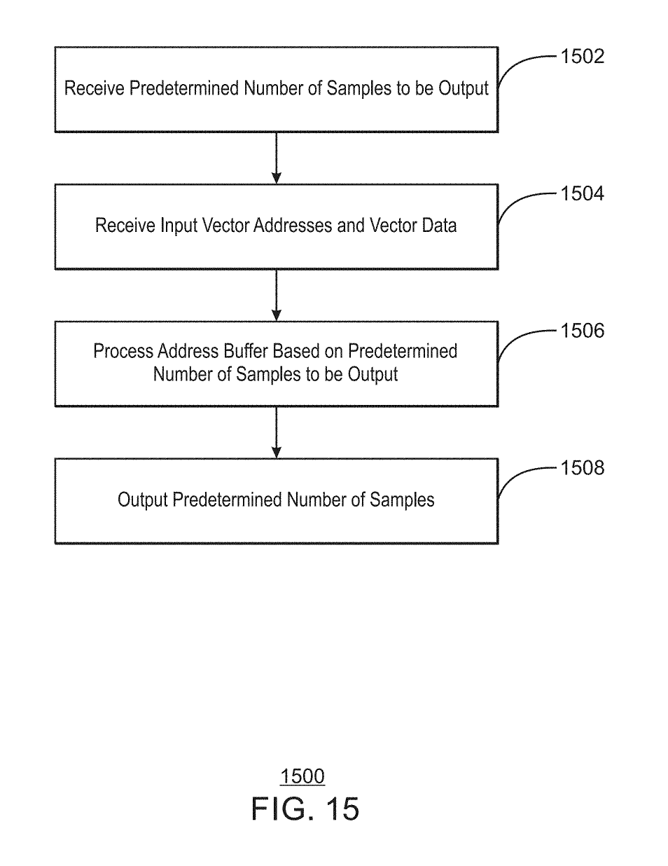

In some examples, the specified time-shape of an instruction may not match the actual vector data being processed. For example, three scenarios may be possible given a particular distribution of random samples. In the first scenario, the memory subsystem 106 may deliver the vector data exactly according to specified time shape. Thus, the time shape of the instruction may match the randomness of the distribution exactly. In another example, the memory subsystem 106 may deliver the output vector data in less than the specified number of clock cycles. In this example, the memory may wait for the specified time-shape, and deliver the output vector at the requested clock-cycle. In another example, the memory subsystem may use more than specified number of clock cycles to deliver the output vector. In this example, the memory can issue a stall signal until the system 100 is ready to deliver the full vector of data. The processing of the output vector at further stages may thus be delayed. In some examples, the system 100 may output a partial vector instead of issuing the stall signal. Thus, the system 100 may be configured to operate in either a fixed-schedule or a fixed performance mode as described in greater length with respect to FIGS. 14 and 15 below.

The diagram of FIG. 1 is not intended to indicate that the example system 100 is to include all of the components shown in FIG. 1. Rather, the example system 100 can be implemented using fewer or additional components not illustrated in FIG. 1 (e.g., additional FIFOs, memory banks, etc.). For example, as described above, although the system may have Nb memory banks, the system may be reconfigured to use a smaller number of memory banks to reduce latency.

FIG. 2 is a detailed block diagram illustrating example system including set of memory banks assigned to a subset of samples from an example region of interest. The example set of memory banks is referred to generally by the reference number 200 and can be implemented in the image processing unit 1626 of the computing device 1602 below. For example, the example system 200 can be implemented in the multi-bank memory 1630 of the computing device 1602.

The example system 200 includes a data segment 202 that contains a number of samples 204 that are to be loaded. For example, the data segment 202 may be a region of interest in an image. A set of memory banks 206 are to store the data segment 202, which includes samples 204 including groups 208.

In FIG. 2, the data segment or Region of Interest (ROI) 202 may thus be stored in the memory banks of the proposed memory subsystem. For example, the memory subsystem may be the memory subsystem of FIG. 1 above. In some examples, the physical memory may be implemented using multiple banks 206, and rather than one monolithic memory bank. A memory controller may be used to store the data segment 202 into the memory banks. As discussed above, the memory controller may be a hardware device which features a sophisticated reading and writing scheme with built in address history. The memory controller may thus store samples 204 across Nb individual memory banks. In some examples, each memory bank is one sample wide. In some examples, the memory banks may be multiple samples wide. The addresses of the requested samples 204 are provided to the memory controller, and the memory controller may keep a history of the requests. In some examples, the memory controller may maintain Na sample addresses at any point in time. The use of multiple memory banks may thus enable better read coverage of the samples 204, scattered around the data region of interest (ROI) 202. For example, when samples 204 that are required to be fetched are scattered around the ROI 202, using several addresses may be much more efficient than using one address. For example, since a set of several addresses may have greater chance that more elements are read in parallel, this may result in a larger average throughput.

The diagram of FIG. 2 is not intended to indicate that the example system 200 is to include all of the components shown in FIG. 2. Rather, the example system 200 can be implemented using fewer or additional components not illustrated in FIG. 2 (e.g., additional banks, samples, bank capacity, etc.).

FIG. 3 is a block diagram of an example two dimensional data split into three example types of memory banks. The example memory banks are referred to generally by the reference numbers 300A, 300B, and 300C, and can be implemented in the image processing unit 1626 of the computing device 1602 below. For example, the example memory banks 300A, 300B, or 300C, can be implemented in the multi-bank memory 1630 of the computing device 1602 below.

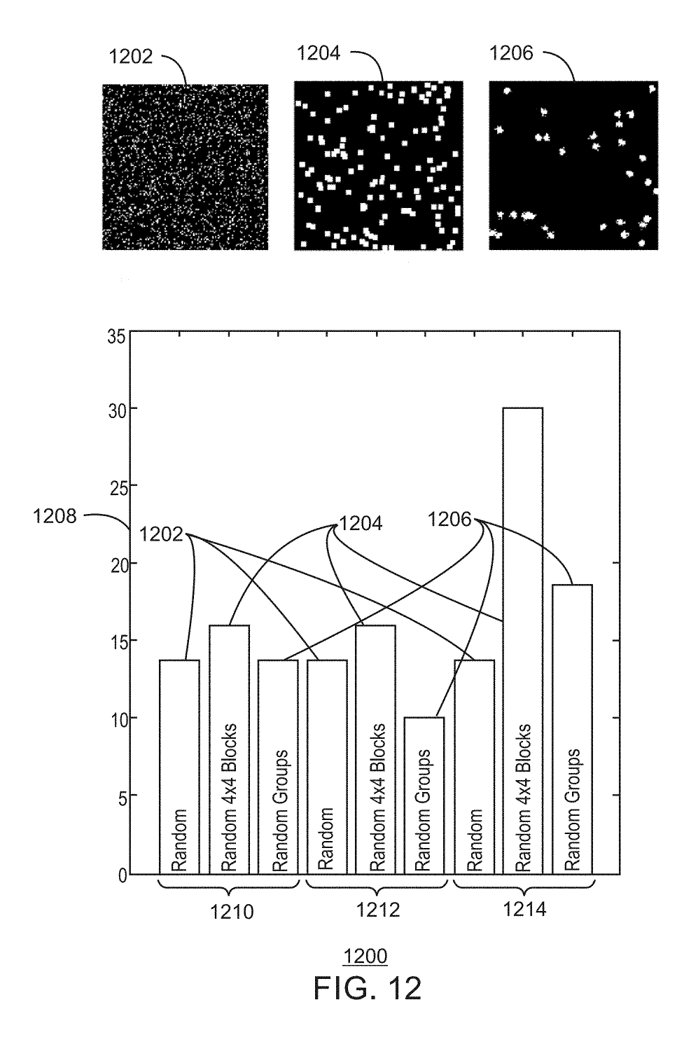

As shown in FIG. 3, 2D data may be split into different memory banks in various ways. For example, a region of interest of 64×32 samples from an image size of 256×256 samples may be stored. The example memory banks 300A show data stored in single-sample wide memory banks. In particular, 64 memory banks each hold 32 samples, being 1 sample wide and 32 samples deep. The example memory banks 300B show elements being stored in multiple-sample wide memory banks. In particular, each bank is 4 samples wide for a total of 16 banks having a depth of 32 samples each. The example memory banks 300C also show multiple sample wide memory banks of 4 samples in width. However, the memory banks 300C split the stored data across memory banks in a skewed manner. By skewing the addressing of elements such as samples when storing them to the memory banks 300C, the system may enable faster access to 2D groups of samples such as 4×4 blocks. For example, skewing the addresses may prevent address conflicts from occurring during the reading of the memory banks. Moreover, skewing may particularly enable the improved reading of random groups of samples as described with respect to FIG. 12 below.

The diagram of FIG. 3 is not intended to indicate that the example memory banks 300A, 300B, and 300C are to include all of the components shown in FIG. 3. Rather, the example memory banks 300A, 300B, and 300C can be implemented using fewer or additional components not illustrated in FIG. 3 (e.g., additional sample widths, additional samples per memory bank, additional memory banks, and different depths of memory banks, skews, etc.).

FIG. 4 is a block diagram illustrating the operation of an example address scheduler that can schedule addresses to be written to or read based on a history of addresses. The example address scheduler is referred to generally by the reference number 400 and can be implemented in the image processing unit 1626 of the computing device 1602 below. For example, the example address scheduler 400 can be implemented in the memory controller 1632 of the computing device 1602.

In some examples, an address history 402 may be included enable hardware address scheduling. For example, instead of trying to place the address immediately into the memory bank reading, a delay of N steps may be introduced to make dense reading based on a larger number of addresses and memory bank combinations. In some examples, by taking into account the values of the addresses that were submitted for the current access, and also within the recent history, the address scheduler 104 may further increase reading efficiency. For example, the address scheduler 404 may thus enable the memory to perform reads from all the banks available.

In some examples, the amount of time (or clock cycles) required to fetch the full NWAY vector of samples matched to a vector address, may not be constant, and may depend on the actual content of the vector data, and a current location of the samples within the ROI. However, the number of clock cycles used to fetch all samples within a vector may be predictable within some margins, assuming truly random data.

In some examples, vector addresses may be supplied in NWAY groups. If the number of vectors of addresses is denoted by NVa then the total number of scalar addressed may be calculated using the equation:

Na=NVa*NWAY Eq. 1

where NWAY is equal to the width of the SIMD of the vector processor. In some examples, the vector processor may have settings of NWAY=32. In some examples, the vector processor may have settings of NWAY=64, or NWAY=16, or some other value. The NVa vector addresses may be used to generate a pool of Na addresses 408 that can be entered into the address scheduler 404 in order to pick up the Nb 410 number of addresses 406 that can be submitted to Nb individual memory banks. For example, the address scheduler 404 may determine a number Nb of scalar addresses that can be read in one clock cycle without bank conflicts. In this way, the address scheduler 404 may increase the use of parallel reading from the Nb memory banks. In some examples, the longer the history (larger Na, and thereby larger NVa), and more banks to operate on (a larger Nb), the better the schedule that the address scheduler 404 may be able to generate.

The diagram of FIG. 4 is not intended to indicate that the example address scheduler 400 is to include all of the components shown in FIG. 4. Rather, the example address scheduler 400 can be implemented using fewer or additional components not illustrated in FIG. 4 (e.g., additional addresses, memory banks, etc.).

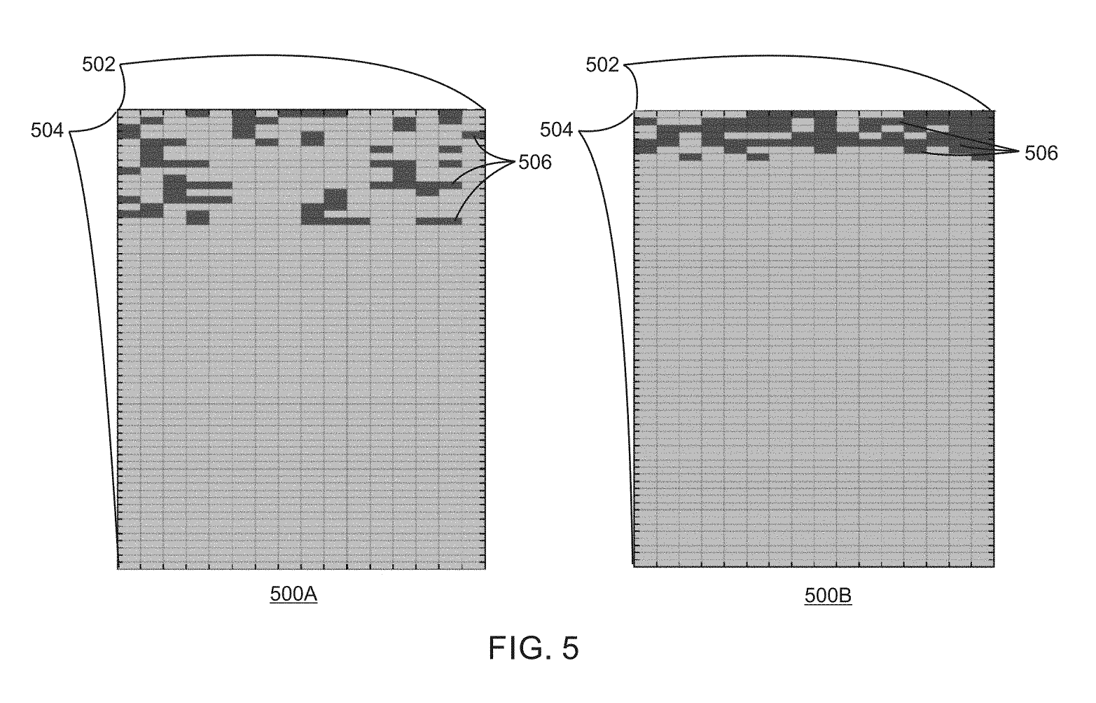

FIG. 5 is a pair of block diagrams illustrating the reading efficiency of an example system without an address buffer versus an example system with an address buffer. The example systems are referred to generally by the reference numbers 500A and 500B and can be implemented in the image processing unit 1626 of the computing device 1602 below.

As shown in FIG. 5, a number of data points or addresses 506 may be read simultaneously at a number of memory banks 502 over a number of clock cycles 504. For example, 64 random addresses 506 may be read from 16 memory banks 502.

In the example of 500A, a vector processor may process scattered data without an address buffer to increase the schedule density. a larger amount of clock cycles 504 are used to read the same number of data points 506 as a smaller average number of data points 506 are read simultaneously with each clock cycle 504. For example, 500A shows that the 64 random addresses 506 are read within 16 clock cycles 504.

In the example of 500B, the vector processor may include an address buffer to increase the schedule density. In some examples, it may take multiple clock cycles to transfer the address data. However, this delay is also not very important since the transfer may happen in parallel while the previous data is being fetched. In this example, the same number of 64 addresses 506 may be read within 7 clock cycles 504 in the resulting compressed reading schedule. Although both examples 500A and 500B are shown reading the 64 addresses in less cycles than the worst case scenario of 64 addresses, or one address per cycle, the example of 500B is able to read the same number of addresses 506 in less than half the clock cycles 504 of example 500A. Therefore, the use of an address buffer, such as the address buffer described in FIG. 1 above, may significantly increase the speed and thus efficiency of reading scattered samples.

The diagram of FIG. 5 is not intended to indicate that the example system 500 is to include all of the components shown in FIG. 5. Rather, the example system 500 can be implemented using fewer or additional components not illustrated in FIG. 5 (e.g., additional addresses, clock cycles, memory banks, etc.).

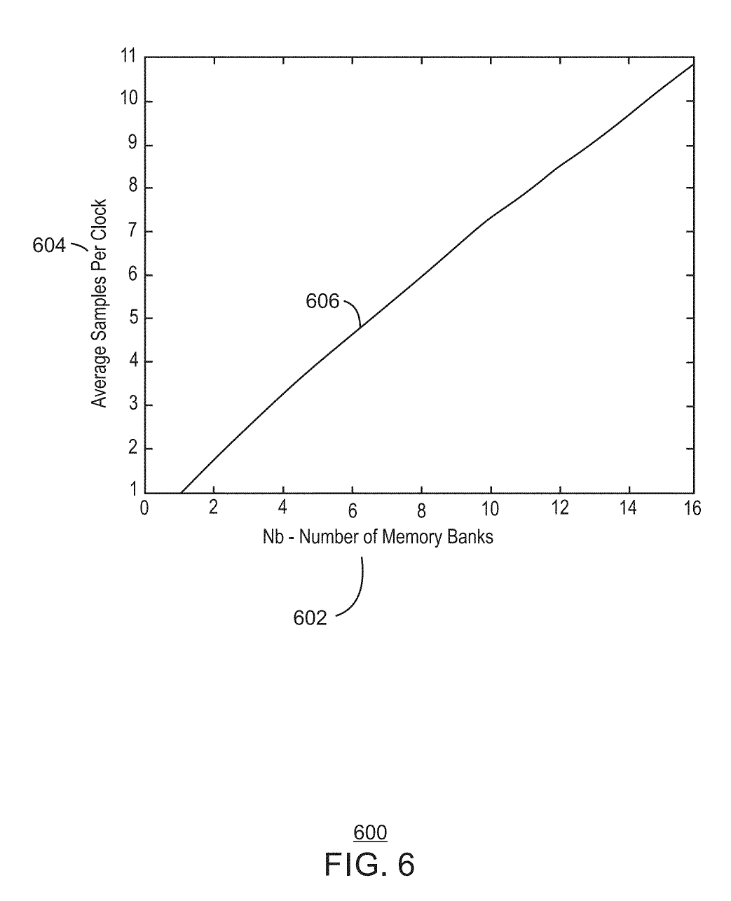

FIG. 6 is a graph illustrating average read performance as a function of number of memory banks. The graph is generally referred to using the reference number 600.

The graph 600 shows that the average number of samples per clock (SPC) 604 grows nearly linearly with an increasing number Nb of memory banks 602. For system configurations that are the same but for the differing number of memory banks 602 of Nb=8, and Nb=16, the achieved average SPC performance 604 can be SPC=6, and SPC=11, respectively. Thus, an additional factor of 2-3× performance improvement can be achieved by doubling the number of memory banks 602. Therefore, multiple memory banks may be used to increase the average samples per clock read.

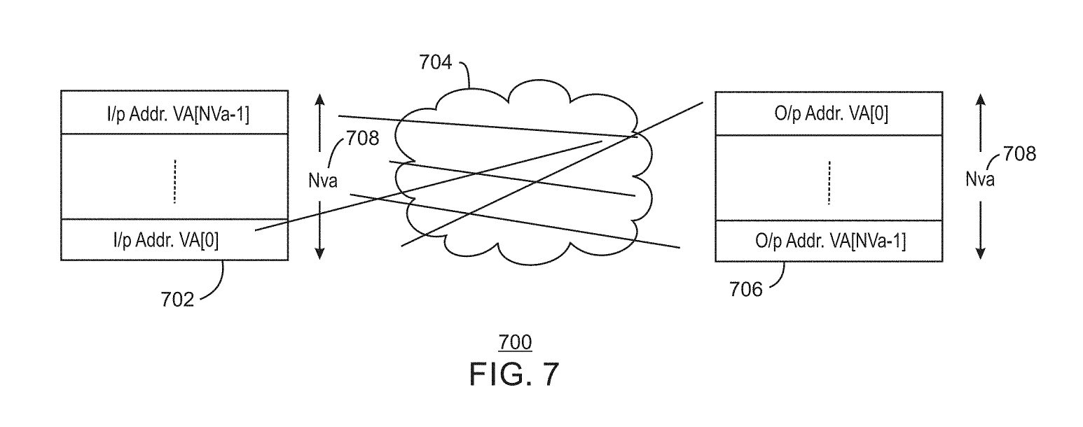

FIG. 7 is a block diagram illustrating an example system with a shuffling stage for writing data from memory banks to internal destination vector registers. The example system is referred to generally by the reference number 700 and can be implemented in the image processing unit 1626 of the computing device 1602 below. For example, the example system 100 can be implemented in the multi-bank memory 1630 and memory controller 1632 of the computing device 1602.

The system 700 includes a buffer of input addresses 702, a shuffling stage 704, and an output register 706 including output addresses. The buffers each have a number of vector addresses 708 of Nva.

As shown in FIG. 7, after sample data is read from Nb memory banks, writing back the read sample data to the output register 706 may take place. For example, the output register 706 may have a capacity of NWAY*NVa. In some examples, a shuffling stage 704 may be used in order to put the sample data back to the proper destination registers. For example, the sample data may be placed back into the sample registers. However, including a shuffling stage 704 may be costly to implement in hardware.

Thus, an alternative method may be used to avoid having to process the sample data through a shuffle stage 704. For example, while scheduling each sample, the position of each sample within a vector address may be recorded. Recording the sample position may include two components. First, a few bits may be used to record the vector address to where the sample belongs. For example, the number of bits may be log 2 (NVa). In addition, a few bits may be used to record the location of a sample within the NWAY samples. For example, the number of bits may be log 2 (NWAY). Together, these bits may compose the address within the output stage of the memory where each of the Nb samples are to be written. In some examples, these Nb samples may then be written to a register file consisting of NWAY*NVa samples. In order to write all Nb samples in parallel, the register file may have a total of Nb ports. Given the capacity of the register file is quite small (NVa*NWAY), the area paid for such an implementation is limited. Moreover, such an implementation may be equal to 4*32=128 registers. Thus, the additional costs of implementing a hardware shuffling stage 704 may be avoided using a few bits to record and keep track of sample locations.

The diagram of FIG. 7 is not intended to indicate that the example system 700 is to include all of the components shown in FIG. 7. Rather, the example system 700 can be implemented using fewer or additional components not illustrated in FIG. 7 (e.g., additional stages, buffers, vector addresses, etc.).

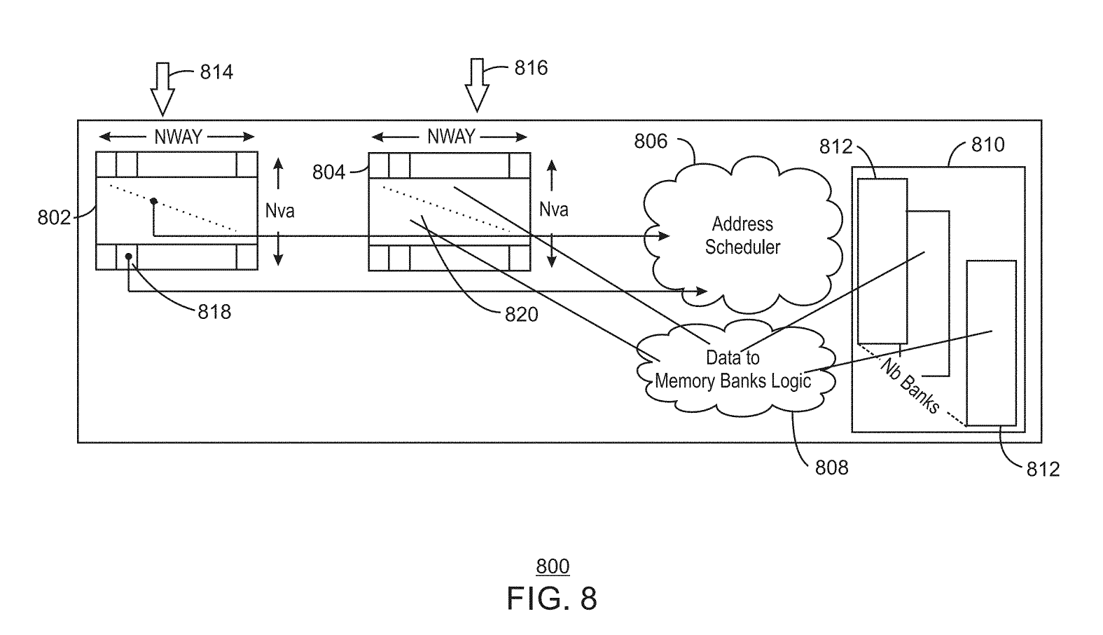

FIG. 8 is a block diagram of an example system for writing data to random memory locations. The example system is referred to generally by the reference number 800 and can be implemented in the image processing unit 1626 of the computing device 1602 below. For example, the example system 800 can be implemented in the multi-bank memory 1630 and memory controller 1632 of the computing device 1602.

The example system 800 includes an address buffer 802, a data buffer 804, an address scheduler 806, a memory logic 808, and a memory subsystem 810 with a number of memory banks 812. The address buffer 802 is receiving a vector address 814 and the data buffer 804 is receiving a vector data 816.

As discussed above and below, various methods may be used for reading from a set of random locations. However, the similar principles can be also applied to writing data to random locations. For example, NVa address vectors and NVa data vectors may be supplied to the memory. Roughly the same elements can thus be used for writing data to random memory locations.

For example, an address scheduler 806 may similarly use address scheduling to determine the way of accessing the multiple Nb memory banks 812. Corresponding data elements 808 may then be written to the memory banks 812 based on the corresponding schedule. The read operation may use the output data buffer and the address logic to unpack the data that is read from the memory banks 802 and 804. For the write operation, the same amount of data may be kept in the input data buffer 804 as depicted in FIG. 8. However, additional logic 808 may be used to route the data 816 corresponding to the scheduled addresses to the corresponding memory banks 812. In this way, data may be written to random memory locations in the memory banks 812.

The diagram of FIG. 8 is not intended to indicate that the example system 800 is to include all of the components shown in FIG. 8. Rather, the example system 800 can be implemented using fewer or additional components not illustrated in FIG. 8 (e.g., additional stages, buffers, memory banks, vector addresses, etc.).

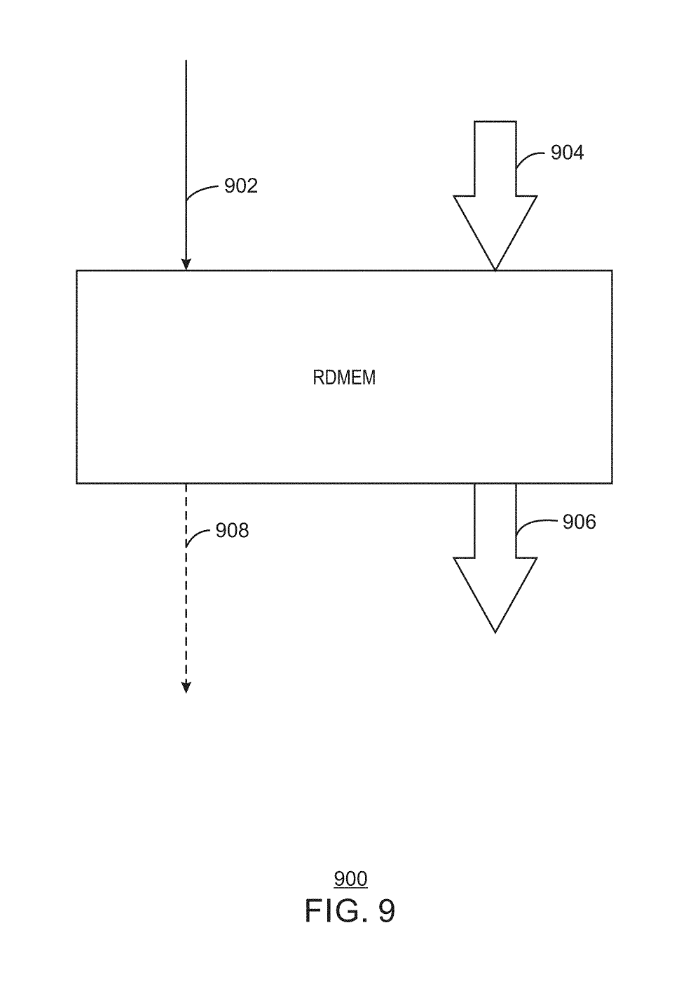

FIG. 9 is a block diagram illustrating interfaces of an example memory subsystem with a fixed schedule. The example memory subsystem is referred to generally by the reference number 900 and can be implemented in the image processing unit 1626 of the computing device 1602 below. For example, the example memory subsystem 900 can be implemented in the multi-bank memory 1630 and memory controller 1632 of the computing device 1602 below.

The example memory subsystem 900 is receiving a vector address 902 and vector data 904, and outputting vector data 906 and scalar data 908. In some examples, depending on the selected type of the memory, the memory subsystem 900 will have slightly different interfaces. For example, the two types of memory may be fixed-schedule memory and fixed-performance memory.

In both types of memory, a vector address input 902 may have a width of NWAY. The vector address input 902 may include addresses of each of the NWAY requested samples in the vector data input 904. In some examples, the input vector addresses 902 may be provided as byte addresses. In some examples, the input vector addresses 902 may be provided as x and y offsets to a reference (0, 0) or the top-left sample within the region of interest.

In addition, both types of memory may receive a vector data input 904. The vector data input 904 may also have a width of NWAY. The vector data input 904 may include data samples to be written to the memory at specified memory locations.

Both data types may further output a vector data output 906. The vector data output 906 may also have a width of NWAY. The vector data output 906 may include data samples that are read out of the memory from specified address locations.

However, the fixed schedule type of memory may also have an additional scalar output 908. The scalar output 908 may be used to indicate how many valid samples are provided at the output of the memory.

The interface of the memory may thus be defined as two inputs and one or two outputs, depending on the type of memory. Within the context of the vector-nature of the vector processor (VP) of the image processing unit (IPU), the address vector 902 may be provided as a vector-shaped input. The second input 904 is a vector of samples 904 to be written into the memory subsystem 900. The output 906 is the vector of read samples, corresponding to the addresses as specified at the input 902. The operation of these two types of memories is described at greater length with respect to FIGS. 14 and 15 respectively.

The diagram of FIG. 9 is not intended to indicate that the example memory subsystem 900 is to include all of the components shown in FIG. 9. Rather, the example memory subsystem 900 can be implemented using fewer or additional components not illustrated in FIG. 9 (e.g., additional inputs, outputs, etc.). For example, when data is being written there may be no output 906, 908. When data is being read, there may only be data at output 906, 908. Data being read at port 906 may contain a vector of fully or partially valid samples. The number of valid samples can be indicated at the output port 908. For example, only the left-most Nv samples at the vector output 906 may be valid. Thus, an Nv value will be provided at 908 port. Alternatively, the valid read samples may be located at the locations corresponding to their addresses from the address vector from port 902.

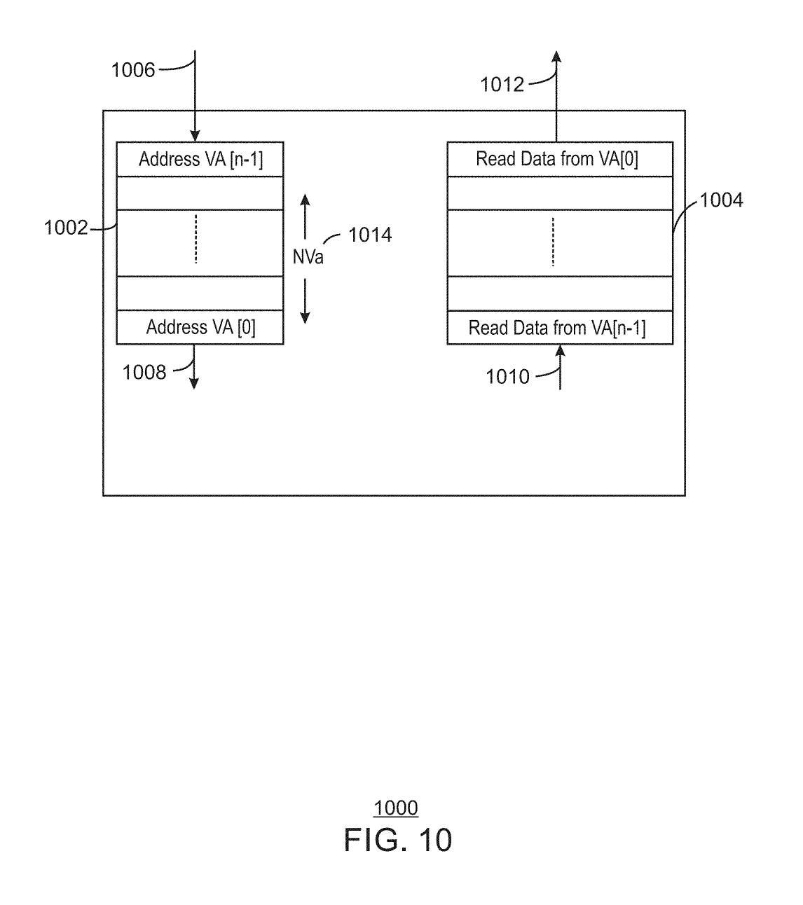

FIG. 10 is detailed block diagram illustrating an example system for prefetching scattered data. The example system is referred to generally by the reference number 1000 and can be implemented in the image processing unit 1626 of the computing device 1602 below. For example, the example system 1000 can be implemented in the multi-bank memory 1630 and memory controller 1632 of the computing device 1602.

As shown in FIG. 10, the example system 1000 may receive vector addresses 1006 at an address buffer 1002. For example, the address buffer 1002 may be a FIFO buffer. In some examples, each vector address may correspond to one sample. For example, one (x, y) pair address may be provided per sample. In some examples, the latency of the system 1000 may be proportional to the number of vector address NVa 1014. For example, a larger number of vector addresses within the address buffer history may result in a larger latency. The latency may be introduced in scheduling performed by the memory controller between the address output 1008 and data input 1010. However, the increased latency may result in a much more efficient output 1012. The system 1000 may thus efficiently output vector sample data 1012 from the data buffer 1004.

The diagram of FIG. 10 is not intended to indicate that the example system 1000 is to include all of the components shown in FIG. 10. Rather, the example system 1000 can be implemented using fewer or additional components not illustrated in FIG. 10 (e.g., additional inputs, outputs, buffers, vector addresses, etc.).

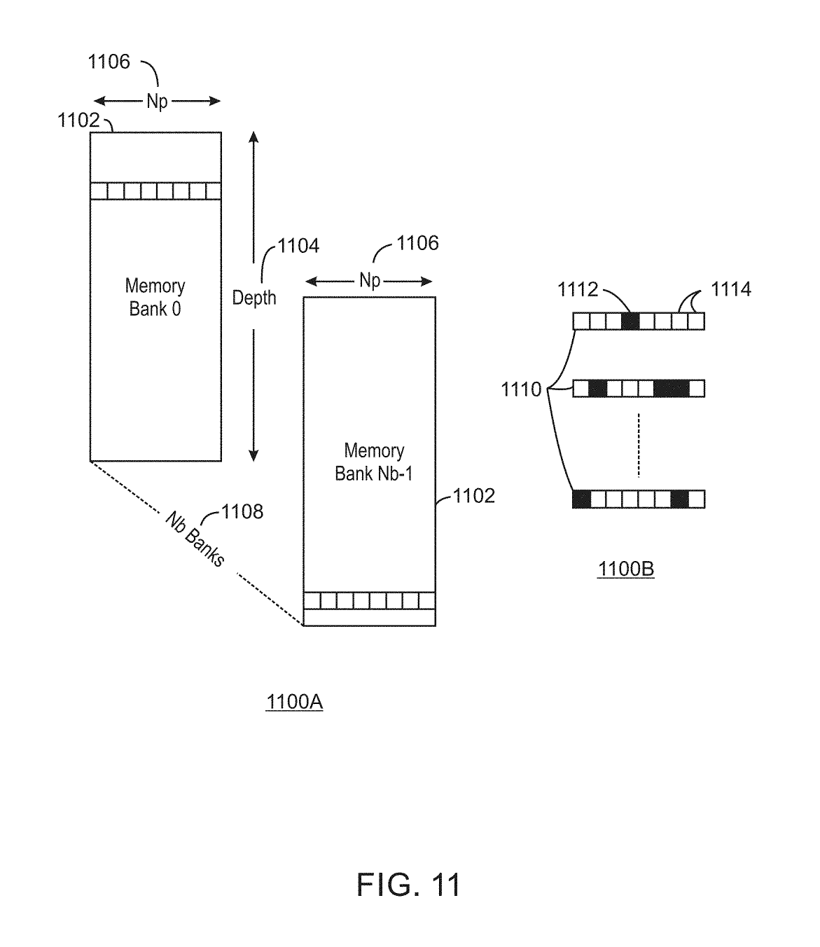

FIG. 11 is a block diagram illustrating an example multi-sample multi-bank memory. The example multi-sample multi-bank memory is referred to generally by the reference number 1100 and can be implemented in the image processing unit 1626 of the computing device 1602 below. For example, the example multi-sample multi-bank memory 1100 can be implemented in the multi-bank memory 1630 and memory controller 1632 of the computing device 1602.

In some examples, the internal microarchitecture of the memory 1100 may be such that the samples are stored across Nb individual memory banks, where each location contains Np samples. Thus, the memory may be called multi-sample, multi-bank memory. The vector addresses 1006 of the requested samples may be provided to a memory controller (not shown). The memory controller may record a history of requests, maintaining at all times Na sample addresses, corresponding to NVa 1214 vector addresses. In some examples, the data to be read may be localized, or grouped, and the likelihood of fetching a group of valid samples within the same address may thus be larger. Therefore, multiple memory banks coupled with multiple samples per bank may enable better read coverage of such groups of samples, scattered around a data region of interest (ROI). When samples that are required to be fetched are scattered around the ROI, trying to cover them with several addresses each containing Np samples may be much more efficient than just with one address per sample.

In FIG. 11, the black samples 1112 indicate a valid, requested samples. From each loaded memory address, there may be anywhere from 1 to an Np number of valid samples. However, the actual number may not be predictable due to the randomness of the samples. Thus, the scheduler may schedule the address loading such that the number of read samples per address location is maximized. In some examples, the bank width Np may also be configured to increase the number of read samples per address location. For example, a wider memory bank may result in a higher probability that more valid requested samples are loaded. With a bank width Np, the number of samples read in parallel is Np times more than a single width bank, and thus the chance is higher that more valid samples are read in one parallel read. In some examples, while scheduling, the scheduler may keep track of scalar source addresses from the set of Na sample addresses. The scheduler may then mark where there was a hit so that the corresponding address is not requested in the next scheduling cycle. Thus, the scheduler may increase the probability that a greater number of valid samples are loaded in the next cycle. For example, since Np samples may be read from each bank, some of those Np samples may be requested in different address requests. To increase efficiency, the scheduler may merge these into one request of Np samples and then assign them to corresponding requests afterwards.

The diagram of FIG. 11 is not intended to indicate that the example multi-sample multi-bank memory 1100 is to include all of the components shown in FIG. 10. Rather, the example multi-sample multi-bank memory 1100 can be implemented using fewer or additional components not illustrated in FIG. 11 (e.g., additional sample widths, memory banks, vector addresses, etc.).

FIG. 12 is a chart illustrating the performance of three example random data memory types in terms of an average samples per clock read from three example types of data access patterns. The chart is generally referenced using the reference number 1200.

In the chart 1200, three example data access patterns include a random pattern 1202, a random block pattern 1204, and random groups 1206 are shown. As used herein, random groups refer to different irregular shapes, where samples are close to each other. The vertical axis of graph 1200 represents performance as average samples per clock (SPCs).

The chart 1200 shows the performance of three example data memory types including single sample wide memory 1210, multi-sample wide memory 1212 with 4 sample wide memory banks without scheduling, and multi-sample wide memory with scheduling 1214. In the example data memory types, the word width (or NWAY of the vector processor) is set to 32 samples, the image size is set to 256×256 samples. Moreover, skewing of data is enabled in order to allow the random block pattern 1204 and random groups 1206 to benefit from the skewing feature. The depth of buffers (Nva) in each example is 4 and each buffer has 32 addresses available. The three example memory data types 1210, 1212, 1214 are provided as examples, and different scenarios are possible and described herein.

As shown in FIG. 12, the first three columns 1210 represent the performance of a single-sample wide memory 1210. In particular, 4×4 groups may benefit particularly from the address skewing. In the second three columns, a 4 sample wide set of memory banks were used but only one sample was used from the read batch. The performance for the random samples and random 4×4 blocks was unaffected, while the random groups' performance suffered due to bank conflicts that were not present in the case of single sample wide memory banks. The third group 1214 shows the performance increase when all Np×Nb samples read are utilized. The random groups show an increase in performance from 13 SPC to 20 SPC. The random 4×4 blocks show increase in performance from 16 SPC to 30 SPC. Thus, the processing of images with random blocks and random groups may be particularly benefited by including multi-sample wide memory banks and skewed addressing with address scheduling.

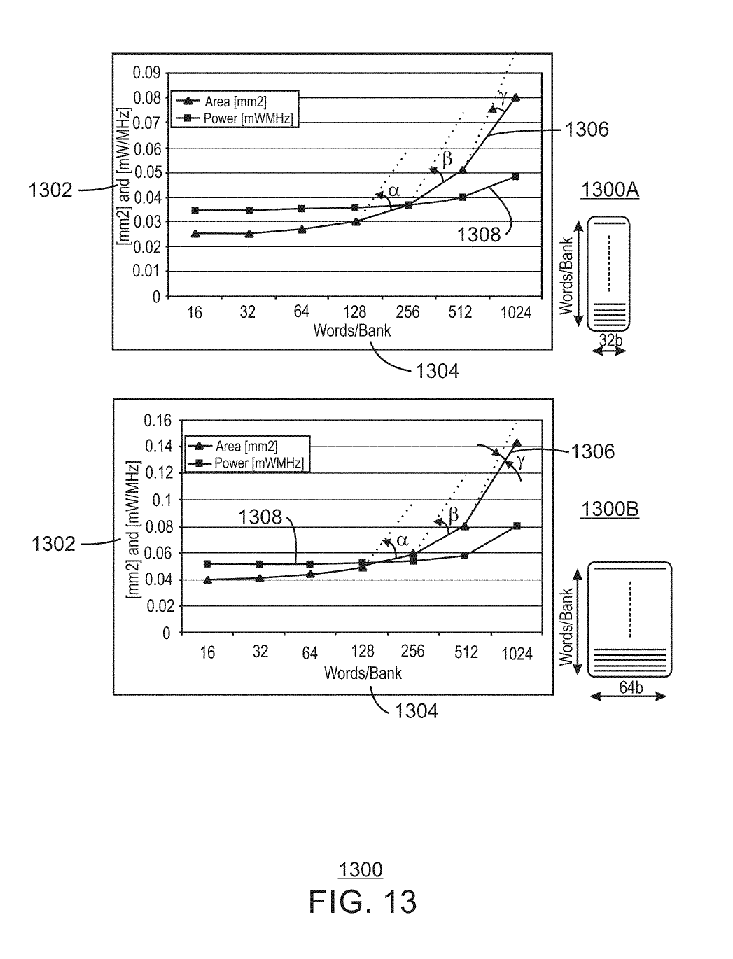

FIG. 13 is a pair of line graphs illustrating silicon efficiency for two example multi-sample width configurations. The configurations are referred to generally by the reference numbers 1300A and 13008, and the multi-sample width configurations can be implemented in the image processing unit 1626 of the computing device 1602 below. For example, the multi-sample width configurations 1300A and 13008 can be implemented in the multi-bank memory 1630 and memory controller 1632 of the computing device 1602.

The multi-sample width configurations 1300A and 13008 of FIG. 13 illustrate a non-linear cost increase of memory banks with an increase of memory bank capacity. In particular, the differences indicated in angles α, β, and γ show the change in silicon efficiency. In general, larger banks result in higher efficiency. Thus, the cost in power or area per memory bit is smaller for certain medium to larger sizes of memory banks. A similar behavior is shown in both analyzed widths of the example memory banks 1300A and 13008. Therefore, a particular distribution of Nb number of banks and Np multiple-sample width can be chosen to reduce costs and increase silicon efficiency when organizing data in memory banks having multiple-sample width. In some examples, the particular number Nb of banks and Np multiple sample width may be based on the particular.

FIG. 14 is a flow chart illustrating a method for prefetching scattered data based on a fixed schedule. The example method is generally referred to by the reference number 1400 and can be implemented in the image processing unit 1626 of the computing device 1602 below. For example, the example method 1400 can be implemented in the multi-bank memory 1630 and memory controller 1632 of the computing device 1602.

At block 1402, the memory controller receives a load instruction. For example, the load instruction may have a time shape. For example, the time shape may indicate the number of clock cycles to complete the load instruction. In some examples, the time shape of the load instruction may be flexible. For example, the time shape may be configurable such that different time shapes may be configured depending on factors including performance and latency. In some examples, the memory controller may reduce a depth of the address buffer via a flexible time shape instruction.

At block 1404, the memory controller receives input vector addresses and corresponding vector data comprising scattered samples. For example, the scattered samples may be randomly scattered, grouped in blocks, or organized in random groups.

At block 1406, the memory controller processes an address buffer based on a time shape of the load instruction. For example, if the latency of a function is set to average latency, then the processor may expect data after that number of cycles. If the data is not there after the number of cycles, then the processor will have to wait and a stall may result at the processing pipeline. In some examples, the memory controller may perform address skewing to increase efficiency, and to provide faster coverage of different 2D shapes. For example, the 2D shapes may be rectangles and squares. In some examples, address scheduling may be implemented based on the time shape of the load instruction. In some examples, the memory controller may process multiple samples in parallel. For example, the memory controller may assign addresses to a multi-bank memory.

At block 1408, the memory controller outputs a partial vector. For example, a subset of the total scattered samples in the input vector data may be output after a predetermined number of clock cycles has completed. Thus, a vector processor may have some output vector data to process at regular intervals. The memory controller may output additional partial vectors at the regular intervals for the vector processor to process.

At block 1410, the memory controller outputs a scalar value indicating a number of valid samples in the partial vector. For example, the number of valid samples in the partial vector may depend on the randomness of the input vector data and the grouping of the input vector data. Since the latency of a fixed-schedule may be fixed, method 1400 may be used when latency is more important than data coherency.

This process flow diagram is not intended to indicate that the blocks of the example process 1400 are to be executed in any particular order, or that all of the blocks are to be included in every case. Further, any number of additional blocks not shown may be included within the example process 1400, depending on the details of the specific implementation. For example, for the fixed-schedule type of the memory, the memory controller may provide for data coherency during writing. Thus, all samples from the input vector may be written to the memory subsystem. In order to enforce that within the fixed time-shape, constraints on the type of the accesses may be used. Therefore, accesses that do not result in a bank conflict may be allowed, while access that result in bank conflicts may not be allowed. Since the memory may be based on Nb banks with one element per bank, all 1D and 2D write accesses are possible, provided that the width of the region is power of two fraction of Nb. In some examples, for a given NWAY and number of memory banks Nb, the number of clock cycles used for a write action may be calculated using the equation:

Nr_write_cycles_=NWAY/Nb Eq. 2

FIG. 15 is a flow chart illustrating a method for prefetching scattered data based on a fixed performance. The example method is generally referred to by the reference number 1500 and can be implemented using the image processing unit 1626 of the computing device 1602 below. For example, the example method 1500 can be implemented in the multi-bank memory 1630 and memory controller 1632 of the computing device 1602.

At block 1502, the memory controller receives a target number of samples to be output. In some examples, the target number of samples may be the number of samples that were input. In some examples, the target number of samples may be a fraction of the number of samples that were input. For example, in order to reduce latency, the target number of samples may be ½ or ¼ of the total number of input samples. In some examples, the number of samples to be output can be specified by user input. In some examples, the number of samples to be output can be a vector size NWAY. In some examples, other values may be used if latency is more important than the number of samples. For example, an NWAY/2 number of samples may be output. In some examples, the values may be limited to powers of two for easier implementation.

At block 1504, the memory controller receives input vector addresses and corresponding vector data comprising scattered samples. For example, the vector addresses of the scattered samples may be randomly scattered, grouped in blocks, or organized in random groups.

At block 1506, the memory controller processes an address buffer based on the predetermined number of samples to be output. For example, the address buffer may be a FIFO buffer. In some examples, the memory controller may process the address buffer until the specified number of samples is produced at the output. In some examples, the memory controller may statistically calculate the latency to deliver the requested number of samples. The memory controller may then predict the average throughput and performance of this memory, and thus subsequent components within the image processing pipeline.

At block 1508, the memory controller outputs the predetermined number of samples. For example, the samples may then be processed by additional stages of an image processing pipeline.

This process flow diagram is not intended to indicate that the blocks of the example process 1500 are to be executed in any particular order, or that all of the blocks are to be included in every case. Further, any number of additional blocks not shown may be included within the example process 1500, depending on the details of the specific implementation.

Referring now to FIG. 16, a block diagram is shown illustrating an example computing device that can process images with prefetching of scattered data. The computing device 1600 may be, for example, a laptop computer, desktop computer, tablet computer, mobile device, or camera, among others. In some examples, the computing device 1600 may be a smart camera or a digital security surveillance camera. The computing device 1600 may include a central processing unit (CPU) 1602 that is configured to execute stored instructions, as well as a memory device 1604 that stores instructions that are executable by the CPU 1602. The CPU 1602 may be coupled to the memory device 1604 by a bus 1606. Additionally, the CPU 1602 can be a single core processor, a multi-core processor, a computing cluster, or any number of other configurations. Furthermore, the computing device 1600 may include more than one CPU 1602. In some examples, the CPU 1602 may be a system-on-chip (SoC) with a multi-core processor architecture. In some examples, the CPU 1602 can be a specialized digital signal processor (DSP) used for image processing. The memory device 1604 can include random access memory (RAM), read only memory (ROM), flash memory, or any other suitable memory systems. For example, the memory device 1604 may include dynamic random access memory (DRAM).

The memory device 1604 can include random access memory (RAM), read only memory (ROM), flash memory, or any other suitable memory systems. For example, the memory device 1604 may include dynamic random access memory (DRAM). The memory device 1604 may include device drivers 1610 that are configured to execute the instructions for device discovery. The device drivers 1610 may be software, an application program, application code, or the like.

The computing device 1600 may also include a graphics processing unit (GPU) 1608. As shown, the CPU 1602 may be coupled through the bus 1606 to the GPU 1608. The GPU 1608 may be configured to perform any number of graphics operations within the computing device 1600. For example, the GPU 1608 may be configured to render or manipulate graphics images, graphics frames, videos, or the like, to be displayed to a user of the computing device 1600.

The memory device 1604 can include random access memory (RAM), read only memory (ROM), flash memory, or any other suitable memory systems. For example, the memory device 1604 may include dynamic random access memory (DRAM). The memory device 1604 may include device drivers 1610 that are configured to execute the instructions for generating virtual input devices. The device drivers 1610 may be software, an application program, application code, or the like.

The CPU 1602 may also be connected through the bus 1606 to an input/output (I/O) device interface 1612 configured to connect the computing device 1600 to one or more I/O devices 1614. The I/O devices 1614 may include, for example, a keyboard and a pointing device, wherein the pointing device may include a touchpad or a touchscreen, among others. The I/O devices 1614 may be built-in components of the computing device 1600, or may be devices that are externally connected to the computing device 1600. In some examples, the memory 1604 may be communicatively coupled to I/O devices 1614 through direct memory access (DMA).

The CPU 1602 may also be linked through the bus 1606 to a display interface 1616 configured to connect the computing device 1600 to a display device 1618. The display device 1618 may include a display screen that is a built-in component of the computing device 1600. The display device 1618 may also include a computer monitor, television, or projector, among others, that is internal to or externally connected to the computing device 1600.

The computing device 1600 also includes a storage device 1620. The storage device 1620 is a physical memory such as a hard drive, an optical drive, a thumbdrive, an array of drives, a solid-state drive, or any combinations thereof. The storage device 1620 may also include remote storage drives.

The computing device 1600 may also include a network interface controller (NIC) 1622. The NIC 1622 may be configured to connect the computing device 1600 through the bus 1606 to a network 1624. The network 1624 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The computing device 1600 further includes an image processing unit 1626. For example, the image processing unit 1626 may include an image processing pipeline. The pipeline may include a number of processing stages. In some examples, the stages may process frames in parallel. For example, the pipeline may include an enhanced prefetch stage for efficient reading of scattered data in images. The image processing unit 1626 may further include a vector processor 1628. For example, the vector processor may be capable of processing an NWAY number of samples in parallel. The image processing unit 1626 may further include a multi-bank memory 1630. In some examples, the multi-bank memory may include a number of memory banks with single sample widths. In some examples, the multi-bank memory may include memory banks with multi-sample widths. The image processing unit 1626 may also include a memory controller 1632. In some examples, the memory controller may include an address scheduler 1634 to schedule the storing of addressing into the multi-bank memory 1630. In some examples, the memory controller may include an address history of previously stored addresses. For example, the memory controller may use the address history when scheduling addresses. In some examples, the scheduler may further include skewing logic to perform skewing when scheduling the addresses.

The block diagram of FIG. 16 is not intended to indicate that the computing device 1600 is to include all of the components shown in FIG. 16. Rather, the computing device 1600 can include fewer or additional components not illustrated in FIG. 16, such as additional buffers, additional processors, and the like. The computing device 1600 may include any number of additional components not shown in FIG. 16, depending on the details of the specific implementation. Furthermore, any of the functionalities of the CPU 1602 or image processing unit 1626 may be partially, or entirely, implemented in hardware and/or in a processor. For example, the functionality of the memory controller 1632 may be implemented with an application specific integrated circuit, in logic implemented in a processor, in logic implemented in a specialized graphics processing unit such as the image processing unit 1628, or in any other device.

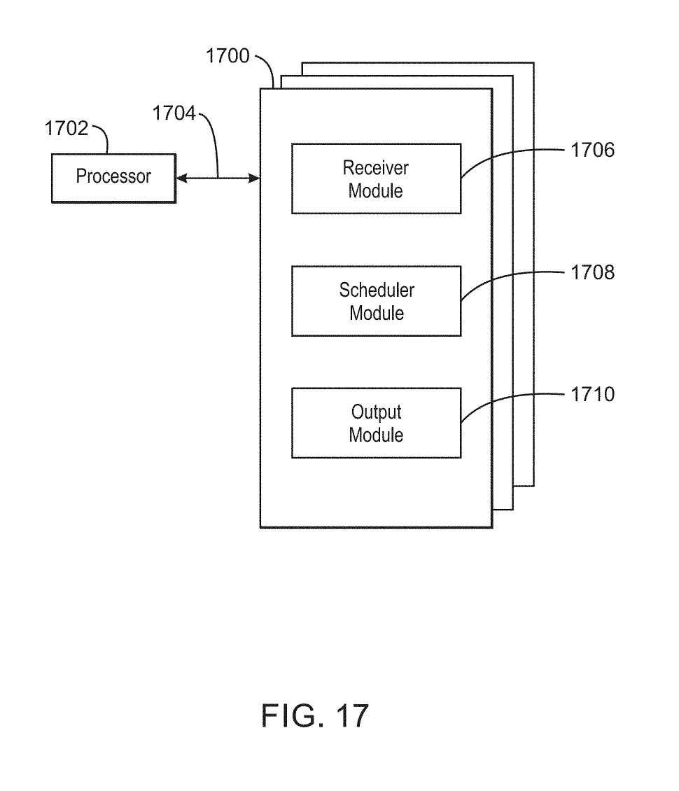

FIG. 17 is a block diagram showing computer readable media 1700 that store code for enhanced prefetching of scattered data. The computer readable media 1700 may be accessed by a processor 1702 over a computer bus 1704. Furthermore, the computer readable medium 1700 may include code configured to direct the processor 1702 to perform the methods described herein. In some embodiments, the computer readable media 1700 may be non-transitory computer readable media. In some examples, the computer readable media 1700 may be storage media. However, in any case, the computer readable media do not include transitory media such as carrier waves, signals, and the like.

The various software components discussed herein may be stored on one or more computer readable media 1700, as indicated in FIG. 17. For example, a receiver module 1706 may be configured to receive a load instruction. The receiver module 1706 may also be configured to receive input vector addresses and corresponding vector data comprising scattered samples. For example, the scattered samples may have random addresses or randomly grouped addresses. In some examples, the receiver module 1706 may also receive a target number of samples to be output. For example, the target number of samples may be an NWAY number of samples or an NWAY/2 number of samples. A scheduler module 1708 may be configured to process an address buffer based on a time shape of the load instruction. For example, the scheduler module 1708 may schedule the storage of received vector data onto a number of memory banks based on the selected time shape. In some examples, the memory banks may be multi-sample wide memory banks. In some examples, the scheduler module 1708 may skew the vector addresses. In some examples, the scheduler module 1708 may process the address buffer based on the predetermined number of samples to be output. For example, the scheduler module 1708 may process the address buffer until the specified number of samples is produced at the output. An output module 1706 may be configured to output a partial vector in a predetermined number of clock cycles. In some examples, the output module 1706 may be configured to output a predetermined number of samples. For example, the predetermined number of samples may be output in any number of clock cycles.

The block diagram of FIG. 17 is not intended to indicate that the computer readable media 1700 is to include all of the components shown in FIG. 17. Further, the computer readable media 1700 may include any number of additional components not shown in FIG. 17, depending on the details of the specific implementation.

### Examples

Example 1 is an apparatus for processing scattered data. The apparatus includes an address buffer to receive a plurality of vector addresses corresponding to input vector data including scattered samples to be processed. The apparatus also includes a multi-bank memory to receive the input vector data and send output vector data. The apparatus further includes a memory controller including an address scheduler to assign an address to each bank of the multi-bank memory.

Example 2 includes the apparatus of example 1, including or excluding optional features. In this example, the multi-bank memory includes single-sample wide memory banks.

Example 3 includes the apparatus of any one of examples 1 to 2, including or excluding optional features. In this example, the multi-bank memory includes multi-sample wide memory banks.

Example 4 includes the apparatus of any one of examples 1 to 3, including or excluding optional features. In this example, the multi-bank memory includes skewed addressing.

Example 5 includes the apparatus of any one of examples 1 to 4, including or excluding optional features. In this example, the plurality of vector addresses include random vector addresses.

Example 6 includes the apparatus of any one of examples 1 to 5, including or excluding optional features. In this example, the plurality of vector addresses include pseudo-random vector addresses.

Example 7 includes the apparatus of any one of examples 1 to 6, including or excluding optional features. In this example, the multi-bank memory includes a number of memory banks corresponding to a number of samples that can be processed in parallel by an associated vector processor.

Example 8 includes the apparatus of any one of examples 1 to 7, including or excluding optional features. In this example, the apparatus is to output a subset of the scattered samples in a predetermined number of cycles.

Example 9 includes the apparatus of any one of examples 1 to 8, including or excluding optional features. In this example, the apparatus is to output a predetermined number of the scattered samples.

Example 10 includes the apparatus of any one of examples 1 to 9, including or excluding optional features. In this example, the apparatus includes an address history, wherein the address scheduler is to assign the address to each bank of the multi-bank memory based on an address history.

Example 11 is a method for processing scattered data. The method includes receiving a load instruction. The method also includes receiving input vector addresses and corresponding vector data including scattered samples. The method further includes processing an address buffer based on a time shape of the load instruction; and outputting a partial vector in a predetermined number of cycles.

Example 12 includes the method of example 11, including or excluding optional features. In this example, the method includes outputting a scalar value indicating a number of valid samples in the partial vector.

Example 13 includes the method of any one of examples 11 to 12, including or excluding optional features. In this example, the method includes reducing a depth of the address buffer via a flexible time shape instruction.

Example 14 includes the method of any one of examples 11 to 13, including or excluding optional features. In this example, the method includes reducing the depth of the address buffer via selecting an alternative time shape instruction.

Example 15 includes the method of any one of examples 11 to 14, including or excluding optional features. In this example, processing the address buffer includes performing address skewing.

Example 16 includes the method of any one of examples 11 to 15, including or excluding optional features. In this example, the load instruction includes a time shape that indicates a number of cycles to complete the load instruction.

Example 17 includes the method of any one of examples 11 to 16, including or excluding optional features. In this example, the partial vector includes a subset of the scattered samples.

Example 18 includes the method of any one of examples 11 to 17, including or excluding optional features. In this example, the method includes outputting additional partial vectors at regular intervals.

Example 19 includes the method of any one of examples 11 to 18, including or excluding optional features. In this example, a number of valid samples in the partial vector depends on the randomness of the input vector data and the grouping of the input vector data.

Example 20 includes the method of any one of examples 11 to 19, including or excluding optional features. In this example, the method includes providing for data coherency during writing.

Example 21 is a method for processing scattered data. The method includes receiving a target number of samples to be output. The method also includes receiving input vector addresses and corresponding vector data including scattered samples. The method further includes processing an address buffer based on the predetermined number of samples to be output. The method also further includes outputting the predetermined number of samples.

Example 22 includes the method of example 21, including or excluding optional features. In this example, the target number of samples to be output includes an NWAY number of samples.

Example 23 includes the method of any one of examples 21 to 22, including or excluding optional features. In this example, the target number of samples to be output includes an NWAY/2 number of samples.

Example 24 includes the method of any one of examples 21 to 23, including or excluding optional features. In this example, processing the address buffer includes processing the address buffer until the specified number of samples is produced at the output.

Example 25 includes the method of any one of examples 21 to 24, including or excluding optional features. In this example, the number of samples to be output is specified by user input.

Example 26 includes the method of any one of examples 21 to 25, including or excluding optional features. In this example, the address buffer includes a first-in, first-out (FIFO) buffer.

Example 27 includes the method of any one of examples 21 to 26, including or excluding optional features. In this example, the method includes processing the predetermined number of samples at an additional stage of an image processing pipeline.

Example 28 includes the method of any one of examples 21 to 27, including or excluding optional features. In this example, the vector addresses of the scattered samples include randomly grouped addresses.

Example 29 includes the method of any one of examples 21 to 28, including or excluding optional features. In this example, the vector addresses of the scattered samples include addresses grouped in blocks.

Example 30 includes the method of any one of examples 21 to 29, including or excluding optional features. In this example, the vector addresses of the scattered samples include randomly scattered addresses.

Example 31 is at least one computer readable medium for processing scattered data having instructions stored therein that. The computer-readable medium includes instructions that direct the processor to receive a load instruction; receive input vector addresses and corresponding vector data including scattered samples. The computer-readable medium also includes instructions to process an address buffer based on a time shape of the load instruction. The computer-readable medium further includes instructions to output a partial vector in a predetermined number of clock cycles.

Example 32 includes the computer-readable medium of example 31, including or excluding optional features. In this example, the computer-readable medium includes instructions to output a scalar value indicating a number of valid samples in the partial vector.

Example 33 includes the computer-readable medium of any one of examples 31 to 32, including or excluding optional features. In this example, the computer-readable medium includes instructions to reduce a depth of the address buffer via a flexible time shape instruction.

Example 34 includes the computer-readable medium of any one of examples 31 to 33, including or excluding optional features. In this example, the computer-readable medium includes instructions to reduce the depth of the address buffer via selecting an alternative time shape instruction.

Example 35 includes the computer-readable medium of any one of examples 31 to 34, including or excluding optional features. In this example, the computer-readable medium includes instructions to perform address skewing.

Example 36 includes the computer-readable medium of any one of examples 31 to 35, including or excluding optional features. In this example, the load instruction includes a time shape that indicates a number of cycles to complete the load instruction.

Example 37 includes the computer-readable medium of any one of examples 31 to 36, including or excluding optional features. In this example, the partial vector includes a subset of the scattered samples.

Example 38 includes the computer-readable medium of any one of examples 31 to 37, including or excluding optional features. In this example, the computer-readable medium includes instructions to output additional partial vectors at regular intervals.

Example 39 includes the computer-readable medium of any one of examples 31 to 38, including or excluding optional features. In this example, a number of valid samples in the partial vector depends on the randomness of the input vector data and the grouping of the input vector data.

Example 40 includes the computer-readable medium of any one of examples 31 to 39, including or excluding optional features. In this example, the computer-readable medium includes instructions to provide for data coherency during writing.

Example 41 is a system for processing scattered data. The system includes an address buffer to receive a plurality of vector addresses corresponding to input vector data including scattered samples to be processed. The system also includes a multi-bank memory to receive the input vector data and send output vector data. The system further includes a memory controller including an address scheduler to assign an address to each bank of the multi-bank memory.

Example 42 includes the system of example 41, including or excluding optional features. In this example, the multi-bank memory includes single-sample wide memory banks.

Example 43 includes the system of any one of examples 41 to 42, including or excluding optional features. In this example, the multi-bank memory includes multi-sample wide memory banks.

Example 44 includes the system of any one of examples 41 to 43, including or excluding optional features. In this example, the multi-bank memory includes skewed addressing.

Example 45 includes the system of any one of examples 41 to 44, including or excluding optional features. In this example, the plurality of vector addresses include random vector addresses.

Example 46 includes the system of any one of examples 41 to 45, including or excluding optional features. In this example, the plurality of vector addresses include pseudo-random vector addresses.

Example 47 includes the system of any one of examples 41 to 46, including or excluding optional features. In this example, the multi-bank memory includes a number of memory banks corresponding to a number of samples that can be processed in parallel by an associated vector processor.

Example 48 includes the system of any one of examples 41 to 47, including or excluding optional features. In this example, the apparatus is to output a subset of the scattered samples in a predetermined number of cycles.

Example 49 includes the system of any one of examples 41 to 48, including or excluding optional features. In this example, the apparatus is to output a predetermined number of the scattered samples.

Example 50 includes the system of any one of examples 41 to 49, including or excluding optional features. In this example, the system includes an address history, wherein the address scheduler is to assign the address to each bank of the multi-bank memory based on an address history.

Example 51 is a system for processing scattered data. The system includes means for receiving a plurality of vector addresses corresponding to input vector data including scattered samples to be processed. The system also includes means for receiving the input vector data and send output vector data. The system further includes means for assigning an address to each bank of the multi-bank memory.

Example 52 includes the system of example 51, including or excluding optional features. In this example, the means for receiving the input vector data include single-sample wide memory banks.

Example 53 includes the system of any one of examples 51 to 52, including or excluding optional features. In this example, the means for receiving the input vector data include multi-sample wide memory banks.

Example 54 includes the system of any one of examples 51 to 53, including or excluding optional features. In this example, the means for receiving the input vector data include skewed addressing.

Example 55 includes the system of any one of examples 51 to 54, including or excluding optional features. In this example, the plurality of vector addresses include random vector addresses.

Example 56 includes the system of any one of examples 51 to 55, including or excluding optional features. In this example, the plurality of vector addresses include pseudo-random vector addresses.

Example 57 includes the system of any one of examples 51 to 56, including or excluding optional features. In this example, the means for receiving the input vector data include a number of memory banks corresponding to a number of samples that can be processed in parallel by an associated vector processor.

Example 58 includes the system of any one of examples 51 to 57, including or excluding optional features. In this example, the system is to output a subset of the scattered samples in a predetermined number of cycles.

Example 59 includes the system of any one of examples 51 to 58, including or excluding optional features. In this example, the system is to output a predetermined number of the scattered samples.

Example 60 includes the system of any one of examples 51 to 59, including or excluding optional features. In this example, the system includes means for assigning the address to each bank of the multi-bank memory based on an address history.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for processing scattered data, comprising:
an address buffer to receive a plurality of vector addresses corresponding to input vector data comprising scattered samples to be processed;
a multi-bank memory to receive the input vector data and send output vector data; and
a memory controller comprising an address scheduler to assign an address to each bank of the multi-bank memory.

2. The apparatus of claim 1, wherein the multi-bank memory comprises single-sample wide memory banks.

3. The apparatus of claim 1, wherein the multi-bank memory comprises multi-sample wide memory banks.

4. The apparatus of claim 1, wherein the multi-bank memory comprises skewed addressing.

5. The apparatus of claim 1, wherein the plurality of vector addresses comprise random vector addresses.

6. The apparatus of claim 1, wherein the plurality of vector addresses comprise pseudo-random vector addresses.

7. The apparatus of claim 1, wherein the multi-bank memory comprises a number of memory banks corresponding to a number of samples that can be processed in parallel by an associated vector processor.

8. The apparatus of claim 1, wherein the apparatus is to output a subset of the scattered samples in a predetermined number of cycles.

9. The apparatus of claim 1, wherein the apparatus is to output a predetermined number of the scattered samples.

10. The apparatus of claim 1, further comprising an address history, wherein the address scheduler is to assign the address to each bank of the multi-bank memory based on an address history.

11. A method for processing scattered data, comprising:
receiving a target number of samples to be output;
receiving input vector addresses and corresponding vector data comprising scattered samples;
processing an address buffer based on the predetermined number of samples to be output; and
outputting the predetermined number of samples.

12. The method of claim 11, wherein the target number of samples to be output comprises an NWAY number of samples.

13. The method of claim 11, wherein the target number of samples to be output comprises an NWAY/2 number of samples.

14. The method of claim 11, wherein processing the address buffer comprises processing the address buffer until the specified number of samples is produced at the output.

15. The method of claim 11, wherein the number of samples to be output is specified by user input.

16. At least one computer readable medium for processing scattered data having instructions stored therein that, in response to being executed on a computing device, cause the computing device to:
receive a load instruction;
receive input vector addresses and corresponding vector data comprising scattered samples;
process an address buffer based on a time shape of the load instruction; and
output a partial vector in a predetermined number of clock cycles.

17. The at least one computer readable medium of claim 16, comprising instructions to output a scalar value indicating a number of valid samples in the partial vector.

18. The at least one computer readable medium of claim 16, comprising instructions to reduce a depth of the address buffer via a flexible time shape instruction.

19. The at least one computer readable medium of claim 16, comprising instructions to reduce the depth of the address buffer via selecting an alternative time shape instruction.

20. The at least one computer readable medium of claim 16, comprising instructions to perform address skewing.
